(19) United States
(12) Patent Application Publication
(10) Pub. No.: US 2007/0056407 A1
(43) Pub. Date: Mar. 15, 2007

(54) Hose clamp removal and installation tool

(75) Inventor: Richard Thayer, Bellevue, WA (US)

Correspondence Address: BANNER & WITCOFF, LTD., TEN SOUTH WACKER DRIVE, SUITE 3000, CHICAGO, IL, 60606, US

(73) Assignee: Lisle Corporation, Clarinda, IA (US)

(21) Appl. No.: 11/509,943

(22) Filed: Aug. 25, 2006

Related U.S. Application Data
(60) Provisional application No. 60/596,316, filed on Sep. 15, 2005.

(51) Int. Cl. B25B 27/10

(52) U.S. Cl. 81/9.3

(57) ABSTRACT

A hose clamp compression tool for engaging and compressing opposed or opposite end tangs of a hose clamp includes a first fixed plate and jaw and a second fixed plate spaced from the first fixed plate and jaw. The first and second plates are mounted on rails with a sliding jaw also mounted on the rails and positioned between the fixed jaws. The sliding jaw is rotatably adjustable in spacing from the one fixed jaw by means of a threaded rod journaled to the fixed plates and threaded to the sliding jaw.

### CROSS REFERENCE TO RELATED APPLICATION

This is a utility application derived from, incorporating by reference and claiming priority to a provisional application Ser. No. 60/596,316 filed Sep. 15, 2005 entitled “Spring Band Clamp Removal Tool”.

### BACKGROUND OF THE INVENTION

In a principal aspect, the present invention relates to a tool for installation and/or removal of a hose clamp type in the form of a generally circular band with at least first and second projecting end tangs that may be engaged to move toward one another and thereby expand the circumference of the band to release the band from a hose or other clamping operation performed by the band.

Hose clamps are often utilized in the automotive field and for numerous other purposes to retain a hose inserted or fitted onto a tubular shaft, hose fitting or stem. A hose clamp is typically fabricated from metal formed in a circular or other closed loop shape which, when fitted over a hose, will compress the hose onto a shaft or tube. Such hose clamps generally include projecting end tangs which may be compressed or moved toward one another to overcome the elastic forces provided by the clamp band material and thus enable release of the clamp from the hose or other item to which the hose clamp is attached. That is, when replacing a hose attached to mechanical equipment, it is often necessary to remove the hose and thus detach the hose clamp which holds the hose in a fixed position.

Various tools have been proposed to effect such a release of a hose clamp. For example, Thexton offers a hose clamp tool having sku number THX461 which includes a tube having closed opposite ends with a longitudinal slot in the tube extending between the ends of the tube. A moveable plate is incorporated in the tube so that the tangs projecting from a hose clamp may be engaged and compressed between the moveable plate and one end of the tube to thereby expand and release the clamp.

Steck Co. offers a hose clamp tool especially designed for hose clamps made from rod like material or wire. The Steck tool is very similar to the Thexton tool described above.

While such tools provide some functionality which achieves the objective of engaging and holding a hose clamp in an open position, the design of such tools may not provide desired benefits or advantages. For example, a tool construction which may be easily utilized with multiple types of hose clamps is desired. Further, a tool construction which insures that the hose clamps will be appropriately aligned and engaged by a clamp release tool or device is desired. These among other desirable features have led to the development of the present invention.

### SUMMARY OF THE INVENTION

Briefly, the present invention comprises a hose clamp removal tool or device of a type designed to engage the projecting tangs located respectively at the first and second ends of a hose clamp band. The hose clamp tool is effective for use with hose clamps having the shape of a band of metal which has a generally circular form with projecting end tabs or tangs. The hose clamp tool may also be usable with hose clamps of a type made from wire, as well as non-circular clamps. The hose clamp removal tool includes first and second parallel rails connected together by opposed, spaced end plates. An intermediate slide plate is slidably mounted on the rails between the first and second, spaced end plates that are affixed to the parallel rails. The slide plate is threadably engaged by a threaded rod, that is, journaled in the first and second end plates and thus is movable between the first and second end plates upon rotation of the threaded rod. The slide plate and opposed first end plate each include a tang engagement member which, in a preferred embodiment, comprises a transverse slot and a guide ramp which facilitates positioning of the tangs or ends of a hose clamp within the clamp device between the slide plate and a fixed end plate. The rails of the hose clamp are spaced laterally, one from the other, in a manner which facilitates alignment of a hose clamp appropriately between the rails. The rails thus may function to preclude slippage of the hose clamp from the hose clamp tool during operation of the tool. The hose clamp tool may thus be engaged with the tangs of a hose clamp to thereby effectively open or spread the hose clamp. The tool may remain engaged with the hose clamp and facilitate replacement of the hose clamp on a hose once a repair or replacement operation has been effected.

Thus, it is an object of the invention to provide an improved hose clamp tool.

It is a further object of the invention to provide a hose clamp tool which facilitates maintenance of a hose clamp in engagement with the hose clamp tool.

Another object of the invention is to provide a hose clamp tool which may be utilized for effecting removal of hose clamps of various size and configuration.

Another object of the invention is to provide a hose clamp tool which is rugged, easy to use, compact, capable of being made in various sizes, useful in restricted spaces, capable of use in combination with a socket type drive, and generally inexpensive.

These and other objects, advantages and features of the invention will be set forth in the detailed description which follows.

### BRIEF DESCRIPTION OF THE DRAWING

In the detailed description which follows, reference will be made to the drawing comprised of the following figures:

FIG. 1 is an isometric view of an embodiment of the hose clamp tool of the invention;

FIG. 2 is an exploded isometric view of the tool of FIG. 1;

FIG. 3 is a side elevation of the assembled tool of FIG. 1;

FIG. 4 is an end view of an end plate for the tool of the embodiment of FIG. 1 comprising a fixed jaw;

FIG. 5 is a side view of the plate and jaw of FIG. 4;

FIG. 6 is an opposite side view of the plate and jaw of FIG. 4;

FIG. 7 is a cross sectional view of the plate and jaw of FIG. 4 taken along the line 7-7;

FIG. 8 is a side view of a sliding jaw of the embodiment of FIG. 1;

FIG. 9 is a side view of the sliding jaw of FIG. 8;

FIG. 10 is an opposite side view of the sliding jaw of FIG. 8;

FIG. 11 is a cross sectional view of the sliding jaw of FIG. 8 taken along the line 11-11;

FIG. 12 is an end view of a base jaw of the embodiment of FIG. 1;

FIG. 13 is a side view of the base jaw of FIG. 12;

FIG. 14 is a side view of a rail of the embodiment of the tool of FIG. 1;

FIG. 15 is a side view of the knob which is used to rotate a threaded rod that is incorporated in the tool of the embodiment of FIG. 1;

FIG. 16 is a cross sectional view of the knob of FIG. 15; and

FIG. 17 is a side elevation of the threaded shaft or rod which is incorporated into the embodiment of the tool of FIG. 1 and is connected to the knob of FIG. 15.

### DESCRIPTION OF THE PREFERRED EMBODIMENTS

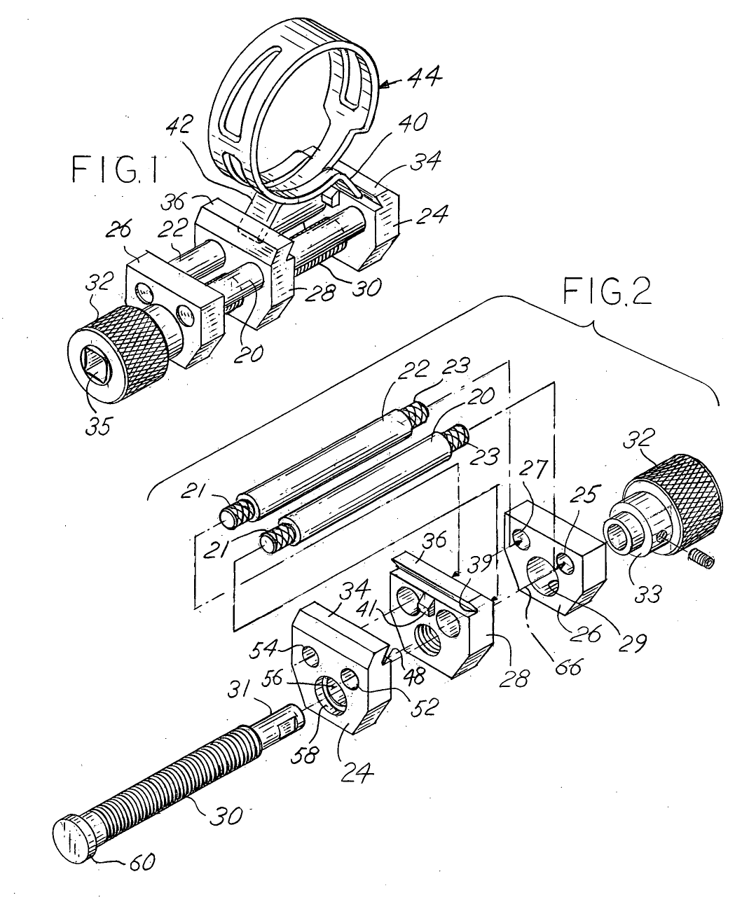

Referring to the figures, an embodiment of the hose clamp tool of the invention is comprised of a multiple number of component parts which are assembled as described herein. Those parts are depicted in an exploded isometric view (FIG. 2) and can be summarized as follows. The tool includes first and second generally cylindrical rails 20 and 22. The first and second rails 20, 22 are designed to connect a fixed, first plate and jaw 24 to a second or base plate 26 which is also affixed to and spaced from the first or fixed plate and jaw 24. A sliding jaw 28 is slidably mounted on the first and second rails 20 and 22 and is threadably engaged by a rotatable, threaded rod 30 journaled through first plate 24 and second or base plate 26. Rod 30 is situated beneath rails 20, 22 with engagement elements or opposed jaws 34, 36 situated along the upper side of the rails 20, 22. Rod 30 may be rotated by means of attached knob 32 to move the sliding jaw 28 axially between first plate 24 and second plate 26. Note, therefore, that the fixed plates 24 and 26 remain at a fixed, spaced distance. Further, the first fixed jaw 24 includes the tang engagement element or member 34 positioned in opposed relationship to tang engagement element or member 36 of the sliding jaw 28.

The tool in the assembled condition, for example as illustrated in FIGS. 1 and 3 is designed to cooperate with and engage the opposite end tabs or tangs 40 and 42 of a hose clamp 44. The hose clamp 44 typically has the form of a flat elongate, generally circular band of material. FIG. 1 depicts a typical type of hose clamp 44. The hose clamp 44 is made from an elastomeric material, typically steel, and is designed to fit around a hose to compress the hose on a tube or stem. By engaging the opposed, radially extending or generally radially extending tabs or tangs 40 and 42 and by moving those tangs 40, 42 toward one another by means of a clamp tool, the elastic pressure exerted on a hose by a band or clamp 44 can be released and the attached hose can then be removed or disengaged from a tube or stem or the like.

Such clamp devices 44 may typically be found in automobile engines where they maintain hose connections for cooling systems and other fluid systems associated with an internal combustion engine. However, hose clamps are used in a myriad of environments and have a myriad of shapes and configurations. The embodiment of the tool of the invention, therefore, is designed for utilization in a broad range of applications and thus such tools are generally universal tools having the function of opening or increasing the diameter of a hose clamp and maintaining that diameter in a fixed, open position and subsequent release thereof.

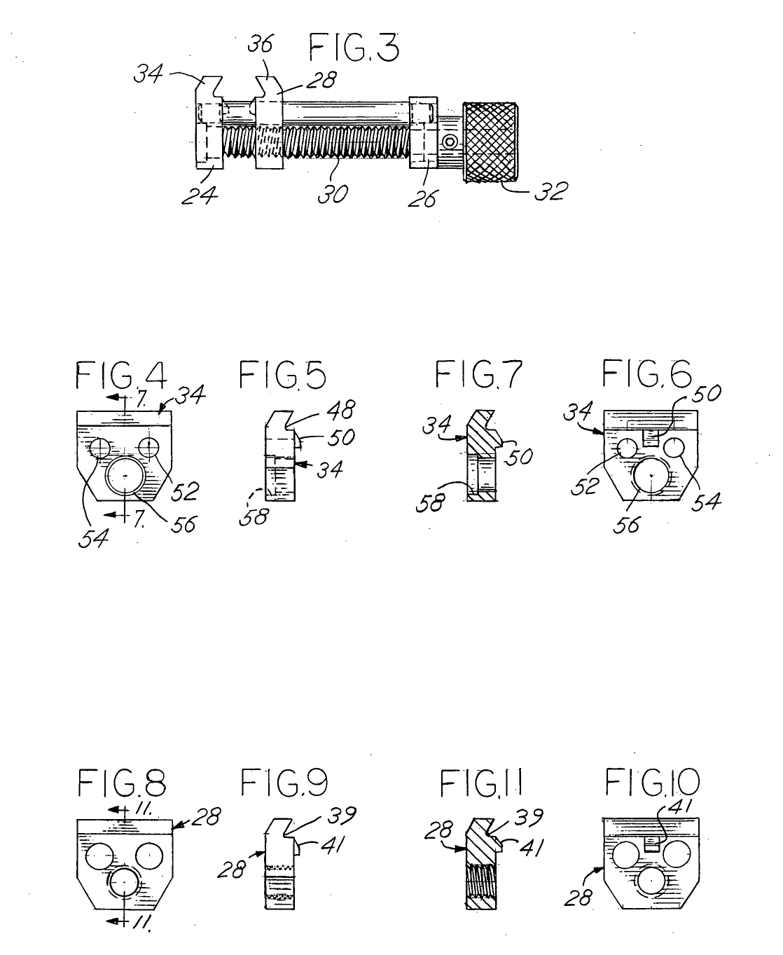

The remaining figures illustrate some of the important features of the invention and as employed in the embodiment depicted. For example, the so-called first fixed jaw 24 is depicted in FIGS. 4-7. That first jaw 24 includes a tang engagement element 34 which comprises a transverse slot 48 into which the end of a hose clamp tang (e.g. 42) may be situated or placed. A ramp member 50 is provided on the inside face of the fixed jaw 24. The first fixed jaw 24 further includes first and second passages 52 and 54 therethrough designed to receive and engage the knurled end of first and second rails 20 and 22, respectively. A typical rail, such as rail 20, is depicted in FIG. 14 and includes opposite, reduced diameter knurled ends 21 and 23 which are designed to engage, for example, openings 52 and/or 54, respectively, and thereby be retained in those openings 52, 54. A central passage 56 through the fixed jaw and plate 24 includes a counterbore 58 which cooperates with a flange 60 at one end of the threaded rod 30. Rod 30 is depicted in greater detail in FIG. 17 wherein the flange 60 which fits into the counterbore 58 is shown. Thus, the rod 30 is rotatable about its longitudinal axis 66 and is journaled to the first and second end plates 24, 26.

The ramp 50 associated with the fixed jaw 24 is inclined inwardly toward the transverse slot 48 and facilitates maintenance of a tang 40 or 42 of hose clamp 44 appropriately in line and retained within the transverse slot 48.

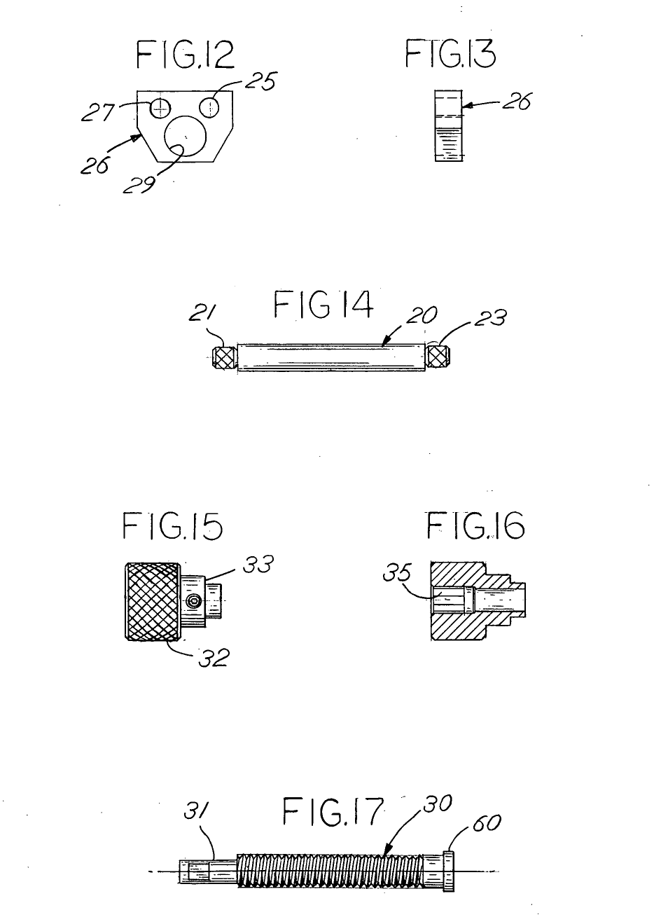

FIGS. 12 and 13 illustrate the base plate 26 or in other words the second fixed plate 26 that cooperates with and is held to the opposite end of the rails 20 and 22 by engagement of knurled, reduced diameter sections 21 or 23 with openings or passages 25 or 27 of the base plate 26. The base plate 26 further includes a passage 29 for journaled and rotatable receipt of the reduced diameter end 31 of the rod 30. Reduced diameter end 31 fits through a compatibly sized passage in the jaw 26 and is fastened to knob 32 by a transverse set screw or pin depicted in greater detail in FIGS. 15 and 16. The knob 32 thus may be pinned to the reduced diameter end 31 of the rod 30. The knob 32 may be knurled on its outside face to facilitate rotation of the knob 32. The knob 32 includes a land 33. The knob 32 further may include a socket opening 35 at its outside end to facilitate engagement by a socket tool to enable driving of or rotation of the rod 30 by means, for example, of a wrench or another tool. This enables providing a mechanical advantage when attempting to rotate the rod 32 to open a hose clamp.

FIGS. 8-11 illustrate in greater detail the sliding jaw 28 with its tang engagement member 36. The tang engagement member 36 includes a transverse slot 39 and further includes a ramp 41 which are designed as a generally mirror image companion to the slot 48 and ramp 50 associated with the fixed jaw 24. The construction of the tang engaging member of the sliding jaw and that of the fixed jaw are substantially identical and in the construction of the tool depicted in the drawings these tang engagement members or elements are arranged in opposed relation so that they can engage and hold the end tangs 40, 42 of a hose clamp 44.

Among the features which are considered to be generally important with respect to the construction described is the spacing of the rails 20 and 22. The first and second rails 20 and 22 are spaced so that they may engage the outside edges or portions of the outside edges of the tangs of a hose clamp 44 and thus retain the hose clamp 44 aligned appropriately and axially in the hose clamp tool. In other words, the rails 20, 22 attempt to preclude the hose clamp 44 and more particularly the tangs 40, 42 of the hose clamp 44 from slipping laterally. Thus, the tangs 40, 42 of a hose clamp 44 may fit between the rails 20, 22 or alternatively be otherwise restrained laterally by the engagement thereof with the sides of the tangs 40, 42 of the hose clamp.

Another feature relates to the portion of the axially extending rails 20, 22 intermediate the generally parallel rod 30 and the jaws 34, 36. At least in part due to this arrangement of parts, the torsional or twisting forces on rails 20, 22 are balanced. That is, the intermediate positioning of the rails 20, 22, generally equally between slots 39, 48 and rod 30, is a very stable clamping arrangement and also effectively protects the threads of the rod 30.

In use, the sliding jaw 28 is appropriately spaced from the fixed jaw 24. The jaws 28 and 24 are then aligned with and engaged with the tangs 42 and 40 of the hose clamp 44 and the knob end 32 and rod 30 are rotated to compress the tangs 40 and 42 between the jaws 24 and 28. Because of the design of the tool, the jaws and thus the hose clamp tool itself will remain engaged with a hose clamp even if the clamp has been removed from a hose, tube or stem or the like. This provides an advantage to a mechanic or other individual using the hose clamp tool in that the hose clamp tool may remain in position on a hose clamp after the hose clamp is effectively opened. By remaining on the hose clamp, the hose clamp can be more easily repositioned on the hose and otherwise adjusted for positioning over a hose without further mechanical operations or reattachment of another hose clamp tool.

Certain variations of the tool may be adopted to accommodate the utilization thereof and still comprise practice of the invention. For example, the rails may be interconnected rather than comprising two separate rods. As interconnected members, they may define an intermediate channel which acts as a guide for a projecting dovetail or arm extending from the moveable jaw and thereby eliminate the sliding connection of the moveable jaw on rails or equivalent structure. The spacing of the rails and their particular engagement of spaced openings associated with the fixed plates 24 and 26, however, is believed to be a preferable embodiment in order to facilitate the manufacture of the tool from parts that are easily assembled. The rails may also assume any of a variety of cross sectional shapes keyed to passages in the moveable jaw. The knurled knob may be of various sizes and shapes; for example, it may have an external hexagonal shape. The mechanism for moving the sliding or moveable jaw may be altered; for example, a piston to effect movement of the moveable jaw on a cylindrical rod or other smooth surface rod shape. Thus, while there has been set forth a preferred embodiment of the invention, it is to be understood that the invention is limited only by the following claims and equivalents thereof.

What is claimed is:

1. A hose clamp compression tool for engaging and compressing a hose clamp band, said band including a first and a second outwardly projecting end tang, said first and second tangs in spaced relation and moveable toward one another to expand the circumference of the band, said tool comprising, in combination:
first and second spaced, generally parallel rails, each rail having first and second spaced ends;
first and second end plates attached respectively to the first end and second end of the first rail and the second rail;
a slide plate slidably mounted on the rails intermediate the first and second end plates;
a threaded rod journaled to said first and second end plates and threaded through said slidable plate, said rod generally parallel to the rails and rotatable to effect sliding movement of the slide plate on said rails, said rod projecting axially from at least one of said end plates and positioned on a first side of said rails;
said first end plate and said slide plate each including an outwardly projecting tang engagement member transversely to said rails on the side of said rails generally opposite the first side, said tang engagement members shaped to engage respectively a first said tang and a second said tang of a said hose clamp band for altering the spacing of said tangs upon rotation of said rod;
said rails laterally spaced from each other.

2. The tool of claim 1 wherein said rails are spaced, separate rod members.

3. The tool of claim 1 wherein said rod includes a manual actuation knob attached to an end of said rod.

4. The tool of claim 1 wherein said rod includes a drive socket.

5. The tool of claim 3 wherein said rod includes a drive socket.

6. The tool of claim 1 wherein at least one of said tang engagement members includes a transverse slot for receipt of a hose clamp tang.

7. The tool of claim 6 further including a tang guide ramp on one of said end plate and slide plate, intermediate said rails.

8. The tool of claim 1 further including first and second separate rails, said rod includes an actuation knob, and said tang engagement members each include a transverse slot for receipt of a hose clamp tang.

9. The tool of claim 1 wherein said threaded rod includes a flange at one end and a reduced diameter section at the opposite end, and wherein one of said end plates includes a counterbore for said flange and the other of said end plates includes a throughbore for said reduced diameter section, and wherein said reduced diameter section projects axially from the other end plate and said knob is attached to said projecting reduced diameter section to retain the spaced end plates from axially spreading apart.
